(19) United States
(12) Patent Application Publication
(10) Pub. No.: US 2019/0187069 A1
(43) Pub. Date: Jun. 20, 2019

(54) System for Inspecting a Tank in a Ship

(71) Applicant: Hawk Robotics AS, Avaldsnes (NO)

(72) Inventors: Daniel Tolås, Karmsund (NO); Håkon Risanger Pettersen, Aksdal (NO)

(73) Assignee: Hawk Robotics AS, Avaldsnes (NO)

(21) Appl. No.: 16/325,773

(22) PCT Filed: Aug. 17, 2017
(86) PCT No.: PCT/NO2017/050205

§ 371 Date: Feb. 15, 2019

(30) Foreign Application Priority Data
Aug. 17, 2016 (NO) 20161312

(51) Int. Cl. G01N 21/954; B63B 9/00

(52) U.S. Cl. CPC G01N 21/954; B66C 21/00; B63B 9/00

(57) ABSTRACT

A system for inspecting a tank in a ship, the tank being suitable for containing cargo in bulk. The system has a support member for supporting at least one sensor means for producing sensor data related to the tank. Also, it has at least three suspending means with an elongated flexible member, adapted to connect to the support member, and a winch, with a motor, for winding a length of the elongated flexible member. Moreover, the system has a control unit for controlling the motor of the winches. The suspending means are adapted to suspend the support member in a position inside the tank. The control unit is configured to synchronize the length of the wound elongated flexible member with the position of the support member inside the tank.

### TECHNICAL FIELD

The present solution relates to a system for inspecting a tank in a ship, the tank being a receptacle suitable for containing cargo in bulk.

### BACKGROUND

Nowadays, one option for transporting cargo in bulk between long-distanced locations is to use a ship comprising at least one tank wherein the cargo in bulk being transported is contained. As a natural consequence of its use, a tank in a ship suffers from physical deterioration over time. Wear and tear defects, in themselves, are not immediately dangerous, but, if unchecked, the deterioration can lead to serious structural defects. If these defects are left undetected and/or without rectification, then serious consequences can ensue, ultimately resulting in the loss of the ship. To avoid the undesirable, and possibly catastrophic, effects of a deteriorated tank, a periodical inspection for defects, such as, e.g., corrosion, deformation, and/or fractures, must be performed in the tank.

However, during the period of time of the inspection, the tank is kept in standby and is not used for containing cargo. This results in fixed costs related to the lack of income resulting from the, otherwise, containment of cargo. It can be estimated that the longer the inspection period, then the higher the loss will be. Hence, although a tank in a ship, suitable for containing cargo in bulk, should be inspected periodically, it should also be inspected in a minimal duration in order to minimize the loss resulting from keeping the tank in standby.

A known solution for performing an inspection in a tank involves emptying the tank and sending personnel therein to visually inspect the tank for defects. A tank in a ship, suitable for containing cargo in bulk, can be much bigger than a human being, for example a tank might be 22 meters high and 25 meters wide. Hence, it is known that when the visual inspection is being performed by the personnel inside the tank, scaffolds may be used in order to reach parts of the tank that would otherwise be unreachable. Such a solution presents several safety risks to the personnel, such as the potential loss of balance or bodily support, and resulting in a fall. Also, the use of scaffolds makes it difficult to change between the locations in the tank being inspected, requiring the personnel to either move it themselves or to disassemble and reassemble it near the next part of the tank being inspected. Alternatively, it is also known that scaffolds can be installed for all the tank, which requires a lot of material and time. Generally, the complete task of inspecting a tank is normally time consuming and depends substantially on the experience and preparation of the personnel performing the task.

### GENERAL DESCRIPTION

Disclosed is a system for inspecting a tank in a ship, the tank being a receptacle suitable for containing cargo in bulk, comprising:
a support member for supporting at least one sensor means for producing sensor data related to the tank;
at least three suspending means comprising an elongated flexible member, adapted to connect to the support member, and a winch for winding a length of the elongated flexible member, the winch comprising a motor for driving the winding of the elongated flexible member;
a control unit for controlling the motor of the winch of the at least three suspending means, wherein the at least three suspending means are adapted to suspend the support member in a position inside the tank, and wherein the control unit is configured to synchronize the length of the elongated flexible member wound of the at least three suspending means, with the position of the suspended support member inside the tank.

The disclosed solution might achieve an efficient movement of the support member inside the tank. Since the position of the support member inside the tank is preferably changeable in any direction, it can thus allow to quickly change the part of the tank which is being inspected. Due to the possible ease in moving the support member within the tank, quicker times for completing the inspection might occur. With a quicker inspection, the tank is more likely to be in stand-by less time, and the overall cost of the inspection may be reduced in comparison to the prior solution.

The suspension of the support member, and correspondingly also of the at least one sensor means, might allow to perform an entire inspection operation without the need for any personnel or the support member itself to physically contact the tank.

Since the system can be implemented in several instances at the same time, it might be possible to inspect several parts of a tank or several tanks in parallel in a ship. These instances can be placed in proximity with one another, for example side by side or in any other suitable configurations to cover the intended parts of the tanks being inspected. Alternatively, several tanks can be inspected in parallel in a ship either with a single instance of the system per tank, multiple instances of the system per tank, or a mix of the two options. This possibility may reduce the total duration of the operation of inspecting all the tanks in a ship down to the longest tank inspection of all.

Preferably, in order to inspect a tank, the system can be set in place once and operated during an entire inspection operation. The suspending means can be a robust means for controlling the suspension of the support member and respective three dimensional movements, which preferably allow performing the inspection operation for as long as needed.

In one embodiment, the support member comprises an elongated member for extending the reach of the support member.

A tank in a ship might comprise locations which are difficult to reach. For example, a tank in a ship may comprise at least one bulkhead stiffener, such as vertical plate stiffeners. These parts could create spaces inside the tank which are difficult to reach with a sensor means supported by the support member. The elongated member of the support member, together with the three dimensional movement of the support member, may allow to reach those spaces inside the tank more easily.

In another embodiment, the support member comprises at least one pivoting means for pivoting the elongated member in one rotation axis in relation to the support member.

The at least one pivoting means for pivoting the elongate member may provide further degrees of freedom for manoeuvring the elongated member in relation to the support member. This aspect may allow to perform the inspection more easily independently of the shape of the tank.

In a further embodiment, the support member comprises at least one electromagnet for fixing the support member to the tank. Advantageously, when the support member comprises an elongated member for extending the reach of the support member inside the tank, the at least one electromagnet is positioned in the elongated member.

Since the support member is suspended in a position inside the tank, it is possible that some disturbances might occur in the balance of the support member while it changes its position inside the tank. In this regard, the at least one electromagnet might provide a way of overcoming these disturbances and achieving a more precise operation of the at least one sensor means.

In one embodiment, the at least three suspending means comprises at least one pulley adapted to be fixed to the tank, for changing the direction of the elongated flexible member.

Advantageously, a pulley of the suspending means may allow to achieve a more adaptable system to different tank architectures. In order to adapt the suspending means for suspending the support member in a position inside the tank, an arrangement of the winch and the elongated flexible member wound therein, might be installed by providing the winch on the floor of the tank and a pulley over it to change the direction of the elongated flexible member towards the support member.

In another embodiment, the control unit comprises a communication means for communicating with the at least one sensor means supported by the support member, and wherein the control unit is configured to receive the produced sensor data from the at least one sensor means.

The reception of the sensor data by the control unit may allow to present the sensor data in a graphical interface in the control unit for the human operator to use as feedback and command the support member position inside the tank in response to that feedback.

Preferably, the communication means may be implemented comprising at least one fibre optic cable woven into at least one of the at least one elongated flexible member comprised by the system. Alternatively, a wireless communication means might be provided, such as ones based in WiFi, Bluetooth, or Zigbee solutions. Other alternatives for a wired or a wireless communication channel might also be used.

In a further embodiment, the support member is adapted to support at least one robotic arm. Advantageously, the at least one robotic arm comprises a marking means for marking the tank.

The presence of a robotic arm supported by the support member might allow to perform the remote actuating actions on the tank. For example, the robotic arm might allow to move movable parts present in the tank out of the way of a sensor means. Another example, is marking the tank where a defect is found. The marker can be provided with highly reflective ink for better visibility of the marks and, correspondingly, of the locations of where possible defects were found.

In one embodiment, when the system comprises a support member adapted to support at least one robotic arm, the communication means of the control unit is adapted for communicating with the at least one robotic arm supported by the support member, and wherein the control unit is configured to control the at least one robotic arm.

With the possibility of the control unit controlling the at least one robotic arm, it is possible that the control unit might automatically actuate the robotic arm in response to some event.

Preferably, the communication means may be adapted by using the same communication channel already in place for the sensor means. Alternatively, it might be implemented with a different communication channel for the specific control of the at least one robotic arm.

In another embodiment, the system comprises four suspending means.

In a further embodiment, a sensor means is any of:
a camera;
a thermal camera; or
an ultrasonic transducer for measuring the thickness of the tank.

The sensor means can be a camera for producing a sensor data related to the tank by capturing images of the tank. Alternatively, the sensor means can be implemented as a thermal camera for capturing thermal readings about the tank. In a further embodiment, the sensor means can be an ultrasonic transducer for capturing readings about the thickness of the tank.

Although in this embodiment some possible sensor means are enumerated, it is to be appreciated that the sensor means might also be distance sensor.

Also disclosed is a ship comprising at least one tank for containing cargo in bulk, wherein the at least one tank comprises the system described above.

In one embodiment, the at least three suspending means of the system are embedded in the at least one tank.

In another embodiment, the control unit of the system is embedded in the tank.

### BRIEF DESCRIPTION OF THE DRAWINGS

So that the invention may be more readily understood, and so that further features thereof may be appreciated, embodiments of the invention will now be described by way of example with reference to the accompanying drawings in which:

FIG. 1 is a schematic illustration showing a cut view of a tank in ship, with a system for inspecting the tank installed therein.

FIG. 2 is a similar illustration showing a second embodiment of a system for inspecting a tank.

FIG. 3 is a schematic illustration of an embodiment of the support member.

FIG. 4 is a schematic illustration similar to FIG. 1, wherein the support member and the control unit are shown in an alternative embodiment.

FIG. 5 is an illustration corresponding generally to FIG. 2, but which depicts an elongate member of the support member, the elongate member being pivoted in relation to the support member.

FIG. 6 is a schematic illustration of an embodiment of the support member with an elongated member.

### DETAILED DESCRIPTION

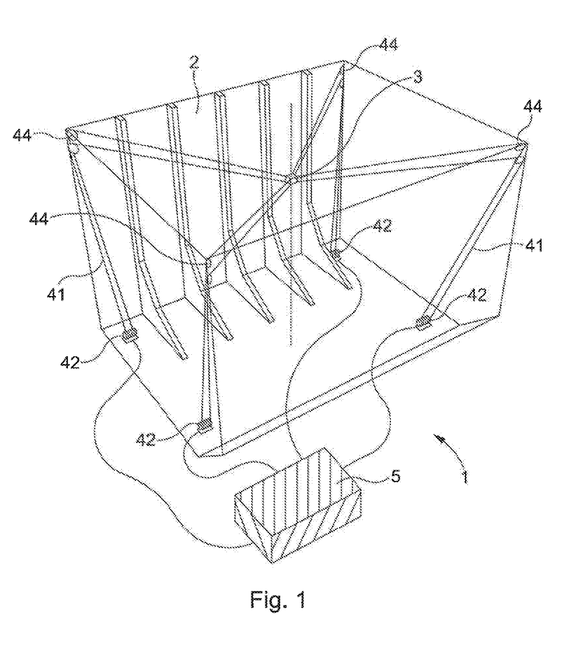

Referring initially to FIG. 1, there is illustrated a system 1 for inspecting a tank 2 in a ship, the tank 2 being suitable for containing cargo in bulk. The tank 2 is shown in a cut view with one visible wall.

The system 1 has four suspending means, i.e. four sets of a winch 42, a cable 41, and a pulley 44. The four suspending means in the system 1 are adapted to suspend the support member 3 in a position inside the tank 2. This is achieved by having the four cables 41 connected to the support member 3, for example with a hook or a carabiner, or with other means for connecting the cable 41 to the support member 3 such as a bolt connector. Moreover, the winches 42 are fixed to the bottom of the tank and the cables 41 change their direction due to the pulleys 44 on the top corners of the tank 2. This makes it possible to manoeuver the support member 3 inside the tank 2 efficiently, allowing to quickly change the part of the tank which is being inspected.

Furthermore, the inspection operation can be performed without the need for any personnel or the support member 3 itself to physically contact the tank. If the support member is lowered or approximated to any of the surfaces of the tank, and all the sensor means therein supported do not require any physical contact with the tank, then no contact will occur since the support member 3 is suspended by the cables 41.

The four winches 42 are controlled by the control unit 5 in order to synchronize the length of the corresponding cable 41 wound in the winches 42, with the position of the support member 3 inside the tank.

Also, the system 1 can be implemented in several instances at the same time. These can be placed in proximity with one another, for example side by side or in any other suitable configurations to cover the intended parts of the tanks 2 being inspected.

Preferably, there is no need to perform a periodic task of recharging batteries or interrupting the inspection operation. The use of the winches 42 allows achieving a robust means for controlling the suspension of the support member 3 and respective three dimensional movements, which preferably allow performing the inspection operation for as long as needed.

The pulleys 44 of the suspending means allow to place the winches 42 on the floor of the tank. The pulleys 44 over them change the direction of the cables 41 towards the support member 3. The winches 42 could also be provided in the upper part of the tank 2, without any pulley 44 in place. The optional presence of a pulley 44 achieves a more adaptable system 1 to different tank architectures.

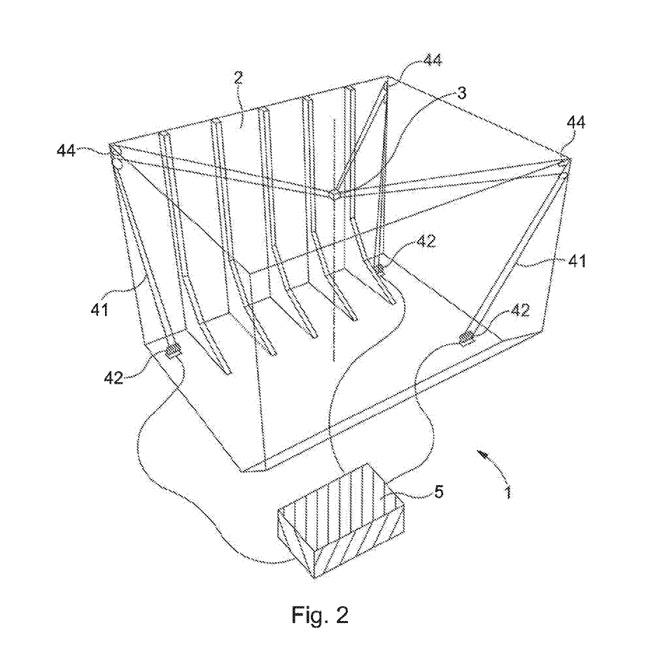

FIG. 2 shows an embodiment of a system 1 installed in tank 2, similar to the embodiment illustrated in FIG. 1, but wherein the system has three suspending means, implemented as sets of a winch 42, a cable 41 and a pulley 44.

The use of three suspending means sets an arrangement which also results in the possibility of manoeuvring the support member 3 inside the tank 2 efficiently.

Furthermore, the inspection operation can also be performed without the need for any personnel or the support member 3 itself to physically contact the tank.

The three winches 42 are also controlled by the control unit 5 in order to synchronize the length of the corresponding cable 41 wound in the winches 42, with the position of the support member 3 inside the tank.

The system 1 of the present embodiment can also be implemented in several instances at the same time. These can be placed in proximity with one another, for example side by side or in any other suitable configurations to cover the intended parts of the tanks 2 being inspected.

Preferably, there is also no need to perform a periodic task of recharging batteries or interrupting the inspection operation since the nature of the suspending means is the same as the previous embodiment.

The pulleys 44 of the suspending means also allow to place the winches 42 on the floor of the tank in this embodiment.

When comparing FIGS. 1 and 2, it is appreciated that there can be at least three suspending means.

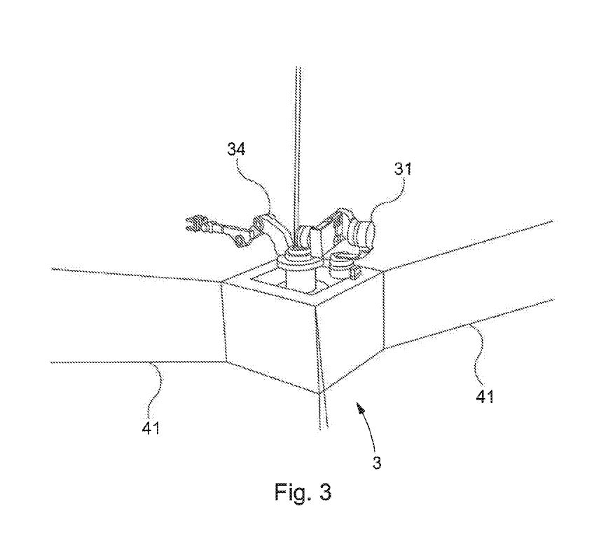

FIG. 3 illustrates an embodiment of the support member 3 shown in FIGS. 1 and 2. The support member 3 is shown supporting a camera, as a sensor means 31, and a robotic arm 34. Furthermore, the support member 3 is in a position inside the tank 2 due to the suspension effected by the elongated flexible 41 therein connected.

The presence of a robotic arm 34 supported by the support member 3 might allow to perform the remote actuating actions on the tank 2. For example, the robotic arm might allow to move movable parts present in the tank 2 out of the way of a sensor means 31. Another example, is marking the tank 2 where a defect is found. The marker can be provided with highly reflective ink for better visibility of the marks and, correspondingly, of the locations of where possible defects were found.

The robotic arm 34 being supported may have a different number of degrees of freedom. For example, a robotic arm 34 with seven degrees of freedom allows achieving movements which are more complex than the ones possible with a robotic arm 34 with two degrees of freedom. On the other hand, a robotic arm 34 with a lower number might allow a higher torque for each degree of freedom.

The sensor means 31 illustrate a camera for producing a sensor data related to the tank 2 by capturing images of the tank 2. Alternatively, the sensor means 31 can be implemented as a thermal camera for capturing thermal readings about the tank 2. In a further embodiment, the sensor means 31 can be an ultrasonic transducer for capturing readings about the thickness of the tank 2.

Although in this embodiment some sensor means are enumerated, it is to be appreciated that the means might also be a distance sensor.

The control unit 5, not shown, can be implemented with a communication means in order to receive the produced sensor data from the sensor means 31. This allows to further use of the sensor data to be implemented by the control unit 5. Such a communication means may be implemented by at least one fibre optic cable woven into at least one of the at least one elongated flexible member 41. Alternatively, a wireless communication means might be provided, such as ones based in WiFi, Bluetooth, or Zigbee solutions.

It is also possible to adapt the communication means to provide the possibility of the control unit 5 controlling the at least one robotic arm 34. This adaptation of the communication means can be performed by using the same communication channel already in place for the sensor means 31 or, in alternatively, it might be implemented with a different communication channel for the specific control of the at least one robotic arm 34.

The support member 3 might also comprise an electromagnet 33, not shown, in order to fix the support member 3 to the tank 2. This allows achieving a more precise operation of the sensor means 31.

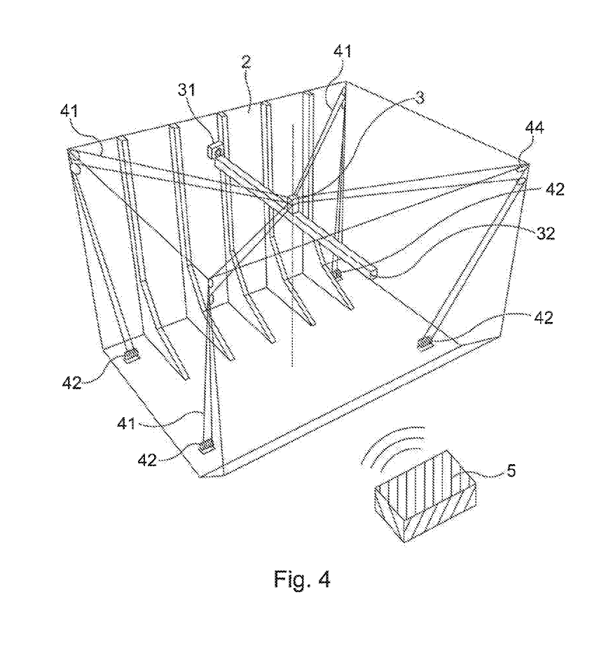

FIG. 4 illustrates an embodiment of the system 1 illustrated in FIG. 1 where the support member 3 and the control unit 5 have been changed. The four suspending means are adapted to suspend the support member 3 in a position inside the tank. Furthermore, the support member 3 has an elongated member 32 extending the reach of the support member 3 inside the tank.

The tank 2 shown has locations which are difficult to reach due to the vertical plate stiffeners therein present. These parts create spaces inside the tank 2 which are difficult to reach with a sensor means 31 supported by the support member 3. The elongated member 32 of the support member 3, together with the three-dimensional movement of the support member 3, allow to reach those spaces inside the tank 2 more easily.

The support member 3 might have at least one pivoting means for pivoting the elongated member 32 in one rotation axis in relation to the support member 3. This aspect provides further degrees of freedom for manoeuvring the elongated member 32 in relation to the support member 3. Hence, the inspection operation can be performed more easily, independently of the shape of the tank 2.

The control unit 5 shown, is illustrated as being of the wireless kind, for controlling the motor of the winches 42 of the four suspending means presented. This aspect is in agreement with the present invention, and the wireless communication capabilities can also be used for implementing a communication means for communicating with the sensor means 31 supported by the elongated member, and receive the produced sensor. Also, if a robotic arm is provided in the elongated member 32 near the sensor means 31 therein supported, the wireless communication capabilities can also be used for implementing a communication means for communicating with the robotic arm and control it remotely.

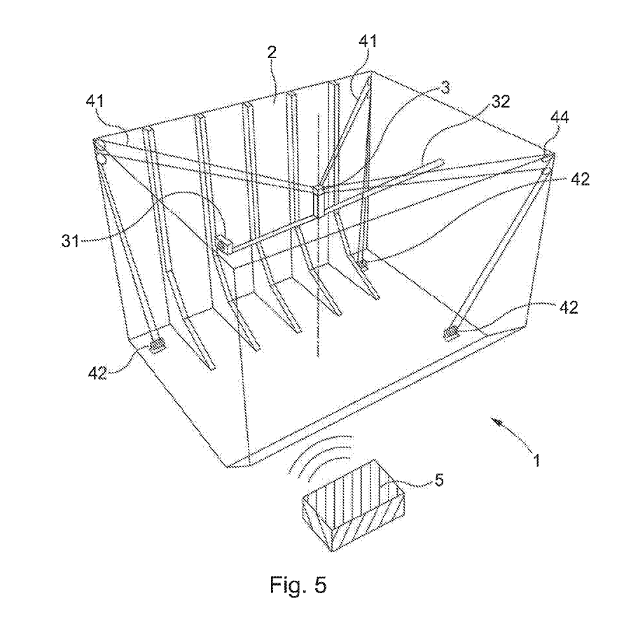

FIG. 5 illustrates an embodiment of the system 1 illustrated in FIG. 2 where the support member 3 and the control unit 5 have been changed. The three suspending means are adapted to suspend the support member 3 in a position inside the tank. Furthermore, the support member 3 has an elongated member 32 extending the reach of the support member 3 inside the tank. It is also appreciated that the same effects and advantages of the embodiment illustrated in FIG. 4 also apply in the present embodiment.

The elongated member 32 of the support member 3, together with the three dimensional movement of the support member 3, also allow to reach those spaces inside the tank 2 more easily.

The support member 3 has at least one pivoting means, which allows to pivot the elongated member 32 in relation to the support member 3. This aspect is shown in the figure providing further degrees of freedom for manoeuvring the elongated member 32 in relation to the support member 3.

The control unit 5 shown, is also illustrated as being of the wireless kind, which entails the same advantageous and effects described for FIG. 4.

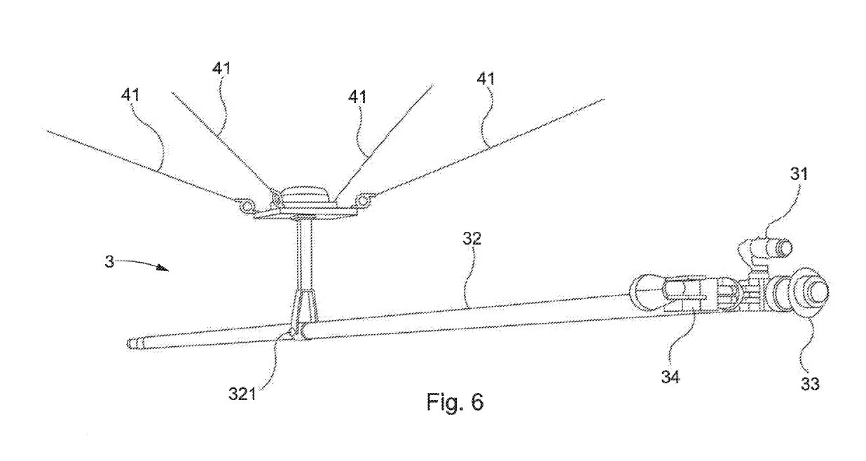

FIG. 6 illustrates an embodiment of the support member 3 shown in FIG. 4, with an elongated member 32. The support member 3 is shown connected to four flexible elongated members 41, which suspend the support member 3 in a position inside the tank 2, not shown. The elongated member 32 is part of support member 3 in connection with the pivoting means 321, which allow pivoting the elongated member 32 in two rotation axis in relation to the support member: heading and elevation.

The elongated member 32 allows to reach spaces of difficult access inside the tank more easily.

The two pivoting means 321 for pivoting the elongate member 32 provide further degrees of freedom for manoeuvring the elongated member 32 in relation to the support member 3. This aspect allows to perform the inspection more easily, independently of the shape of the tank 2.

Since the support member 3 is suspended in a position inside the tank 2, it is possible that some disturbances might occur in the balance of the support member 3 while it changes its position inside the tank 2. In this embodiment, one electromagnet 33 is provided in order to overcome these disturbances and achieving a more precise operation of the at least one sensor means 31. The electromagnet 33 positioned in the elongated member 32.

The elongated member 32 also supports a robotic arm 34, which allows performing a remote actuation on the tank 2. For example, if the robotic arm 34 holds a marking means, it can be used to mark the tank 2 where a defect is found.

It should be noted that although, in some of the figures mentioned above, a tank 2 is illustrated in a cut view with only one wall shown, it is to be appreciated that the system 1 is also suitable for inspecting any other parts of the tank 2.

Also, although some of the figures mentioned above only show the support member 3 supporting sample combinations of at least one sensor means 31 and/or at least one robotic arms 34, it is appreciated that the support member 3 is suitable for supporting any other combinations not presented herein, as needed for an inspection being carried out.

Furthermore, the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. Also, the mere fact that certain measures are recited in mutually different dependent claims does not indicate that a combination of these measures cannot be used to advantage.

1. A system for inspecting a tank in a ship, the tank being a receptacle suitable for containing cargo in bulk, comprising:
a support member for supporting at least one sensor means for producing sensor data related to the tank;
at least three suspending means comprising an elongated flexible member, adapted to connect to the support member, and a winch for winding a length of the elongated flexible member, the winch comprising a motor for driving the winding of the elongated flexible member;
a control unit for controlling the motor of the winch of the at least three suspending means,
wherein the at least three suspending means are adapted to suspend the support member in a position inside the tank, and
wherein the control unit is configured to synchronize the length of the elongated flexible member wound of the at least three suspending means, with the position of the suspended support member inside the tank.

2. The system according to claim 1, wherein the support member comprises an elongated member for extending the reach of the support member.

3. The system according to claim 1, wherein the support member comprises at least one pivoting means for pivoting the elongated member in one rotation axis in relation to the support member.

4. The system according to claim 1, wherein the support member comprises at least one electromagnet for fixing the support member to the tank.

5. The system according to claim 2, wherein the at least one electromagnet is positioned in the elongated member.

6. The system according to claim 1, wherein the at least three suspending means comprises at least one pulley adapted to be fixed to the tank, for changing the direction of the elongated flexible member.

7. The system according to claim 1, wherein the control unit comprises a communication means for communicating with the at least one sensor means supported by the support member, and
wherein the control unit is configured to receive the produced sensor data from the at least one sensor means.

8. The system according to claim 1, wherein the support member is adapted to support at least one robotic arm.

9. The system according to claim 1, wherein the at least one robotic arm comprises a marking means for marking the tank.

10. The system according to claim 7, wherein the communication means of the control unit is adapted for communicating with the at least one robotic arm supported by the support member, and
wherein the control unit is configured to control the at least one robotic arm.

11. The system according to claim 1, comprising a four suspending means.

12. The system according to claim 1, wherein a sensor means is any of:
a camera;
a thermal camera; or
an ultrasonic transducer for measuring the thickness of the tank.

13. A ship comprising at least one tank for containing cargo in bulk, wherein the at least one tank comprises the system described in claim 1.

14. A ship according to claim 13, wherein the at least three suspending means of the system are embedded in the at least one tank.

15. A ship according to claim 13, wherein the control unit of the system is embedded in the tank.

16. The system according to claim 3, wherein the at least one electromagnet is positioned in the elongated member.

17. The system according to claim 4, wherein the at least one electromagnet is positioned in the elongated member.

18. The system according to claim 8, wherein the communication means of the control unit is adapted for communicating with the at least one robotic arm supported by the support member, and
wherein the control unit is configured to control the at least one robotic arm.

19. The system according to claim 9, wherein the communication means of the control unit is adapted for communicating with the at least one robotic arm supported by the support member, and
wherein the control unit is configured to control the at least one robotic arm.

20. A ship according to claim 14, wherein the control unit of the system is embedded in the tank.
